(19) United States
(12) Patent Application Publication
(10) Pub. No.: US 2016/0270120 A1
(43) Pub. Date: Sep. 15, 2016

(54) RECEIVER CHANNEL RESERVATION

(71) Applicant: Telefonaktiebolaget LM Ericsson (publ), Stockholm (SE)

(72) Inventors: Jonas KRONANDER, Knivsta (SE); Robert BALDEMAIR, Solna (SE); Dennis HUI, Sunnyvale, CA (US); Kumar BALACHANDRAN, Pleasanton, CA (US)

(21) Appl. No.: 15/030,930

(22) PCT Filed: Oct. 25, 2013
(86) PCT No.: PCT/SE2013/051252

§ 371 Date: Apr. 21, 2016

(51) Int. Cl. H04W 74/08; H04W 28/26; H04W 16/02

(52) U.S. Cl. CPC H04W 74/08; H04W 16/02; H04W 28/26

(57) ABSTRACT

The present disclosure proposes a solution that increases the efficiency of the MAC and use of the spectrum by indicating in a receiver channel reservation, RCR, signal that the channel is reserved only at the receiver side of a link, during the planned reception by the receiver. The disclosure relates to a method, performed in a first node in a wireless communication system, of reserving a shared media for signal reception, the method comprising defining, parts of the shared media to reserve for signal reception in the first node, configuring a receiver channel reservation signal to indicate the defined parts and transmitting the receiver channel reservation signal to reserve the shared media. The disclosure also relates to a method in a node receiving a receiver channel reservation, RCR, signal and to the corresponding network nodes.

### TECHNICAL FIELD

The disclosure relates to future radio access systems, and more specifically to methods for media access in future radio access systems. The disclosure further relates to methods for reserving and accessing a shared media in radio access systems, as well as to wireless network nodes.

### BACKGROUND

Today's cellular communication occurs mainly in frequency bands below 3 GHz. However, while LTE can operate over bandwidths of as much as 100 MHz by design, the future radio access system envisaged would operate over bandwidths of the order of 1 GHz. Clearly, such a system could not operate in bands below 3 GHz. The lowest band where the mobile industry may home for spectrum parcels that exceed the 10-40 MHz of contiguous allocations typical for the industry is probably above 3 GHz. Out of the regions of spectrum that are most promising for the mobile industry, the cm-Wave, CMW, region from 3-30 GHz and the mm-Wave, MMW, region from 30-300 GHz are particularly interesting for next generation mobile systems.

Furthermore, the IEEE 802.11 standardization effort is planning amendments termed IEEE 802.11ac and IEEE 802.11ad that will enable very high throughput communication over bandwidths such as 160 MHz for the former and 2 GHz for the latter. 802.11ac will operate in the CMW bands such as the 5 GHz ISM band while 802.11ad is targeting the 60 GHz unlicensed band.

Without specifying the exact band where we would operate the future radio access FRA system, the next standard is assumed to operate over bandwidths that range from 100 MHz to 2.5 GHz in dense deployments and over frequency bands that allow the use of beam forming to establish near Line of Sight links between communicating radios.

The resulting system can be used in a variety of scenarios:
1) Point-to-point communications for short range radio systems
2) Access links for a Future Radio Access, FRA, system that provides very high speed connectivity or
3) Backhaul links between densely deployed infrastructure nodes that provide a high throughput pipeline to a network operator's core network; this core network would connect to the Internet and provide access to data and multimedia services.

One of the challenges of operating at MMW frequencies is the received power that decreases with frequency when using omnidirectional antennas because the antenna aperture—which determines how much power is received—decreases with frequency for an omnidirectional antenna and thus also the received power. To overcome this problem antenna area can be increased leading to directive antennas. Generally speaking, directive antennas and beam forming become an important component for MMW communication.

CSMA/CD

Carrier Sense Multiple Access/Collision Avoidance, CSMA/CA, is a contention based medium access mechanism used in the 802.11 standards to allow distributed coordination of the resources among users contending for the medium. In this disclosure CSMA/CD is referred to as an example of a contention based MAC protocol. CSMA/CD is therefore briefly described.

FIG. 1 illustrates a four-way handshaking in a CSMA/CA system based on Request-To-Send/Clear-To-Send, RTS/CTS, for unicast data above a certain threshold. In FIG. 1, a first node, user A, wants to send a data packet to another node, user B. User A then sends a request to send, RTS, to the intended receiver. If the receiver is ready to receive, it broadcasts a clear to send, CTS, message. After receiving the CTS, the sender transmits the packet. All other nodes that receive the CTS refrain from transmission. This mechanism addresses the hidden/exposed terminal problem, described below.

To control the access to the medium, CSMA/CA uses inter-frame spaces, IFS, during which a node has to wait before sensing the channel and determining whether it is free. The 802.11 standard specifies different IFSs to represent different priority levels for the channel access: the shorter the IFS, the higher the priority. For instance, Short IFS, SIFS, is used for immediate acknowledgement of a data frame and Distributed Coordination Function IFS, DIFS, is used to gain access to the medium to transmit data, as further illustrated in FIG. 1.

Furthermore, to allow virtual carrier sensing, every data frame may contain the time needed for its transmission including the ACK, based on this information other nodes, here user C, will maintain a Network Allocation Vector, shown as NAV in FIG. 1, to determine when they should sense the medium again. The NAV is decremented by clock and no access is allowed as long as its value is above 0. The other nodes will again sense the medium after NAV and the subsequent DIFS.

In addition, in order to avoid situations where two nodes transmit at the same time leading to a collision, every node needs to wait for the medium to become free and then invoke the back off mechanism. For this, each node selects a random back off interval, illustrated by the checked box in FIG. 1, within [0, CW], where CW is called the contention window and is initialized to a value CWmin. The node decrements the backoff timer every idle time slot until the counter reaches 0 and the node sends the packet. The CWmin is doubled on each collision until it reaches a maximum threshold called CWmax.

Beam Forming

Beam forming is a general set of techniques to control the radiation pattern of a radio signal. One way of achieving this is to use several fixed antenna elements. The total antenna pattern can be controlled by adjusting the transmit weights of the signal components radiating from each individual antenna element. The beam forming coefficients can be calculated to direct the transmitted energy towards the position of the intended receiver, while simultaneously reducing the amount of energy radiated in unwanted directions.

Transmit beam forming is a key enabler for enhancing the capacity and the energy efficiency in a cellular network and is therefore of major importance in future radio access systems. The received signal strength is increased due to the increased antenna gain resulting from the beam forming operation. At the same time interference is spread over a smaller area, typically resulting in reduced interference levels for all users in the system. Increased Signal to Interference and Noise, SINR, results in higher bit-rates and higher capacity. Higher SINR in a packet oriented system results in shorter packet transmission times. This also helps to reduce the energy consumption in the system since transmitters and receivers can be put into idle mode during a larger ratio of time.

In the simplest form an antenna radiation pattern can be described as pointing in a certain direction with a certain beam width. The direction of the maximum gain of the antenna pattern (usually denoted boresight) can be described as a vector with a vertical component (usually denoted elevation or antenna tilt) and a horizontal component (usually denoted azimuth). The beam width also has two dimensions, one vertical and one horizontal.

Receive beam forming uses the reciprocity of transmit and receive paths to apply directionality towards the receiver. Like transmit beam forming, one way to achieve directivity is to use a number of fixed antenna elements which phases are controlled to steer the direction of the resultant antenna pattern.

The gain of a directive antenna (i.e. the gain by how much the desired signal is amplified over the signal of an omnidirectional antenna) increases with decreasing beam width. The narrower the generated beam the higher the antenna gain.

A well-known problem of contention based MAC protocols when used together with beam forming are hidden nodes. See FIG. 2 for a graphical illustration. In FIG. 2a two transmitters, 20a and 20b, are both contending for the medium—and thus listen to the medium—may not hear each other due to the directive transmissions of the other. At the destination node, 10a, —since both nodes want to communicate with the same node they direct their respective beams towards the common receiver—a collision occurs.

One well known possible way to mitigate this problem is that each transmitter sends prior to the directive transmission an omni-directional pilot signal as illustrated in FIG. 2b. For example, the RTS and CTS described above may be implemented as omnidirectional pilots. Contending transmitter in the neighbourhood can overhear the omni-directional pilot transmission and refrain from accessing the medium.

One drawback with this solution is that it may be overly pessimistic: It avoids all simultaneous transmissions in a neighbour using the same resources. If all transmissions are intended for the same reception node this is also desirable. And all transmissions in the neighbourhood are avoided until the entire message exchange sequence is finished (as described above in the description of the NAV).

However, if not all transmissions are intended for the same receiving node this approach becomes overly pessimistic since even non-colliding transmissions are avoided, see FIG. 3. In FIG. 3 two user equipments 20a, 20b want to communicate with two access nodes 10a, 10b, respectively. Since directed into different directions their transmissions do not collide. However, the omni-directional pilot signals sent by the user equipments 20a, 20b are overheard by the user equipments 20b, 20a, respectively, and therefore both user equipments apply a random back-off according to the MAC protocol.

### SUMMARY

This disclosure provides a method for reserving a media in a contention based wireless communication system. In the current implementations of IEEE 802.11 standards employing RTS/CTS and CSMA/CA schemes a network allocation vector indicates to other nodes that the channel will be busy from reception of the message until a specified future time. All nodes that receive this transmission will obtain the information and hence refrain from transmitting until the NAV timer expires. Receivers of the NAV may in this case miss opportunities of spatial reuse of the communication channel that would have increased the system performance. This is clearly suboptimal use of the spectrum in particular when directional transmissions are employed. The present disclosure therefore introduces the concept of indicating in a receiver channel reservation message that the channel is reserved only at the receiver side of a link, during the planned reception by the receiver.

The present disclosure presents a method in a wireless communication system, of reserving a shared media for signal reception. The method comprises defining, parts of the shared media to reserve for signal reception in the first node and configuring a receiver channel reservation signal to indicate the defined parts. Finally it comprises transmitting the receiver channel reservation signal to reserve the shared media. The proposed solution enables efficient spatial reuse that in prior art is not possible. It is applicable to use in any MAC protocol, in particular in any of the MAC protocols specified in IEEE 802.11 standards.

According to one aspect, the receiver channel reservation signal comprises time information, spatial information, frequency information and/or code information defining parts of the channel being reserved for signal reception. This increases the efficiency of the MAC and use of the spectrum by indicating in a receiver channel reservation, RCR, message that the channel is reserved only at the receiver side of a link and for a very specific time interval, during the planned reception by the receiver.

According to one aspect, the present disclosure relates to a method, performed in a second node in a wireless communication system, of accessing a shared media for signal transmission from the second node to at least one further node. The method comprises receiving, from a first node a receiver channel reservation signal indicating parts of the shared media that the first node is reserving for signal reception and accessing the shared media, using information contained in the received receiver channel reservation signal. By receiving a receiver reservation signal, a first node is able to take own decisions regarding a potential interference. Hence, it is possible to avoid the situation where all nodes that may hear a pilot signal will get the information and hence refrain from transmitting.

According to one aspect, the step of accessing the shared media, comprises refraining from accessing the parts of the shared media that the first node has announced that it has reserved to use for signal reception.

According to one aspect, the method of accessing a shared media further comprises predicting, using the receiver channel reservation signal, an estimate of the interference at the first node of an intended signal transmission from the second node in the direction of the at least one further node and accessing the shared media for transmission based on the determined interference.

According to one aspect, the method of accessing a shared media further comprises adopting an intended directive signal transmission from the second node in order to avoid interfering with the signal reception in the first node.

According to one aspect, the step of accessing the shared media comprises a signal transmission from the second node.

According to one aspect, the disclosure relates to a first node in a wireless communication system, being configured for reserving a shared media for signal reception. The first node comprises a communication unit and processing circuitry. The processing circuitry are adapted to define, parts of the shared media to reserve for signal reception in the first node, configure a receiver channel reservation signal to indicate the defined parts and transmit, using the communication unit, the receiver channel reservation signal to reserve the shared media.

According to one aspect, the disclosure relates to a second node in a wireless communication system, configured for reserving a channel for signal transmission from the second node to at least one further node, the second node comprising a communication unit and processing circuitry. The processing circuitry are adapted to receive, using the a communication unit, from a first node a receiver channel reservation signal indicating parts of the shared media that the first node is reserving for signal reception, and access, using the a communication unit, the shared media, using information contained in the received receiver channel reservation signal.

According to a further aspect, the disclosure relates to a computer program, comprising computer readable code which, when run on a node in a cellular communication system, causes the node to perform the method described above.

With the above description in mind, the object of the present disclosure is to overcome at least some of the disadvantages of known technology as previously described.

### BRIEF DESCRIPTION OF THE DRAWINGS

FIG. 1 illustrates RTS/CTS handshake for collision avoidance in CSMA/CA

FIG. 2a illustrates the hidden node problem.

FIG. 2b illustrates using omni directive pilot signals to reduce the hidden node problem.

FIG. 3 illustrates omni directive pilots refraining transmissions even when the directive data transmissions do not collide.

FIG. 4 illustrates a node sending receiver channel reservation signal.

FIG. 5 is a flowchart illustrating method steps executed in a node transmitting a sending receiver channel reservation signal.

FIG. 6 is a flowchart illustrating method steps executed in a node receiving a receiver channel reservation signal.

FIG. 7a illustrates time intervals indicated in a receiver channel reservation signal.

FIG. 7b illustrates time intervals indicated in a receiver channel reservation signal when one ACK is used to acknowledge several data packets at once.

FIG. 8 illustrates an example of a message exchange sequence for spatial reuse of a channel using a receiver channel reservation signal.

FIG. 9 illustrates another example of a message exchange sequence for spatial reuse of a channel using a receiver channel reservation signal.

FIGS. 10 and 11 are a block diagrams illustrating nodes in a wireless communication system for executing the method of FIGS. 5 and 6 respectively.

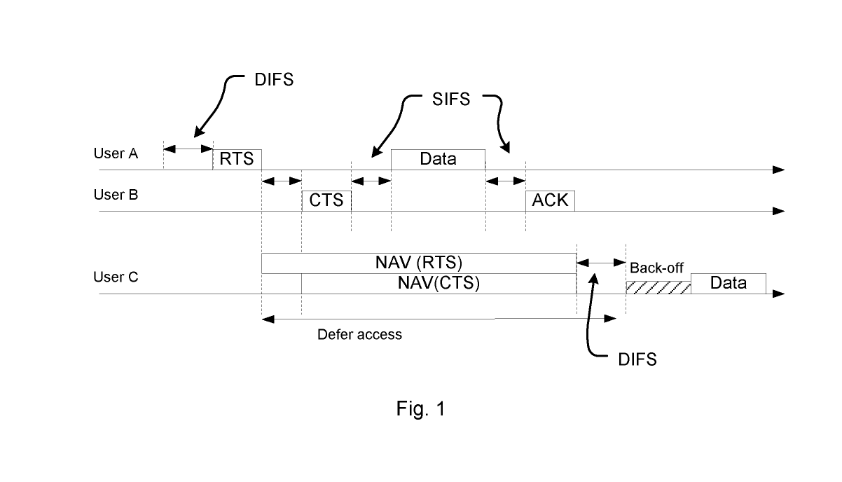

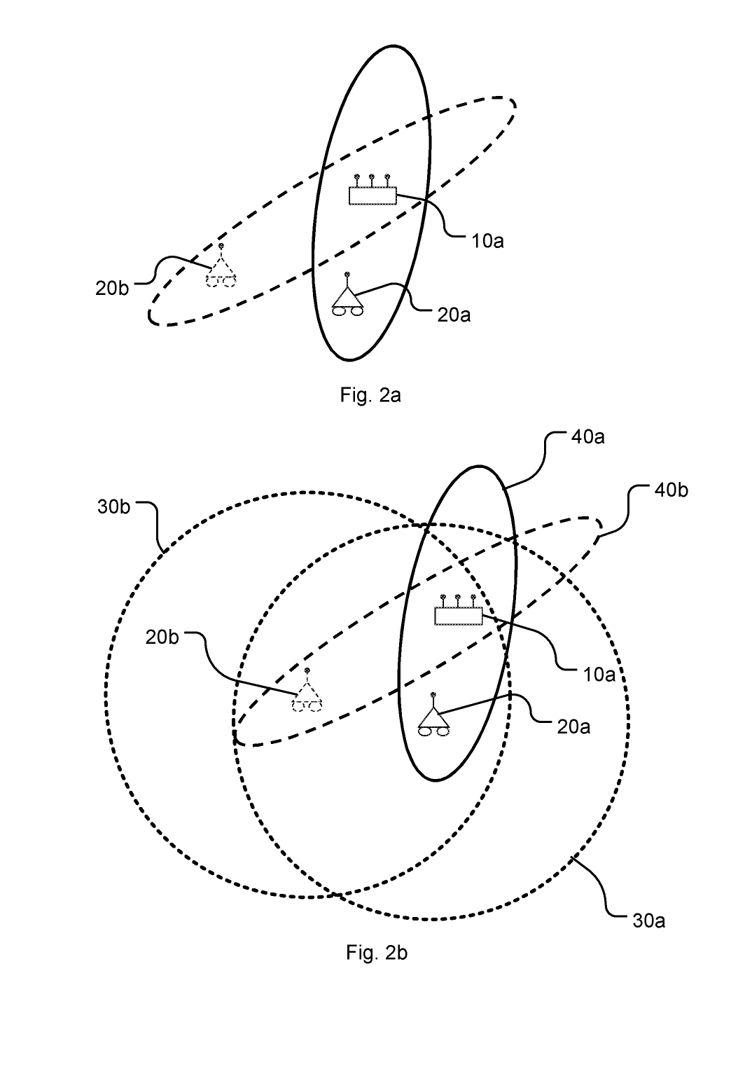

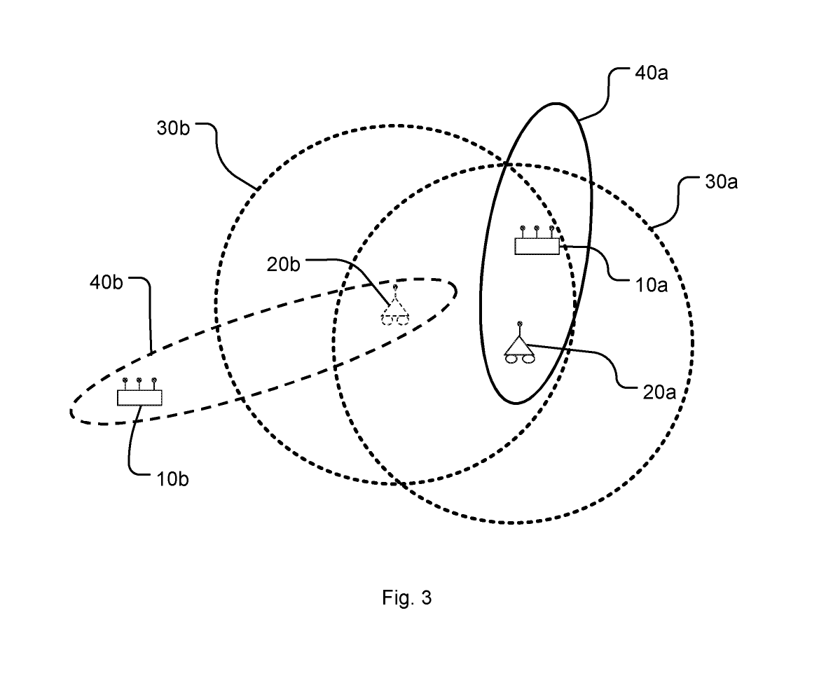

### DETAILED DESCRIPTION

The general object or idea of aspects of the present disclosure is to address at least one or some of the disadvantages with the prior art solutions described above as well as below. The various steps described below in connection with the figures should be primarily understood in a logical sense, while each step may involve the communication of one or more specific messages depending on the implementation and protocols used.

The present disclosure proposes a solution that increases the efficiency of the MAC and use of the spectrum by indicating in a receiver channel reservation, RCR, signal that the channel is reserved only at the receiver side of a link, during the planned reception by the receiver.

Embodiments of the present disclosure are in general directed, to a CSMA/CD system as described above. However, it must be understood that the same principle is applicable in other systems, where nodes are competing for a channel. Such a system may comprise both scheduled and contention based transmissions in any combination. The proposed solution enables more efficient spatial reuse than possible in prior art solutions. The technique is applicable to use in any MAC protocol, in particular in any of the MAC protocols specified in IEEE 802.11 standards. The proposed technique may in some cases only be used in a certain aspect, e.g. only during the initial access, of a communication system that has both scheduled and contention-based modes of operation. It may even be used in a dynamical spectrum sharing scenario (over unlicensed or shared spectrum with registered usage), where multiple different communication systems co-exists where the only common knowledge is where a common pilot channel is located. The disclosure is in particular applicable but not limited to situations where directive communication transmissions are used.

As the surrounding environments of a transmitter and its receiver can be quite different from each other, trying to draw inference about the presence of a nearby destination node from the transmission of a source node can often lead to an erroneous conclusion. The medium may be more effectively protected through omnidirectional pilots transmitted by the destination node, i.e. the intended receiver of the directional transmission, instead of the source node.

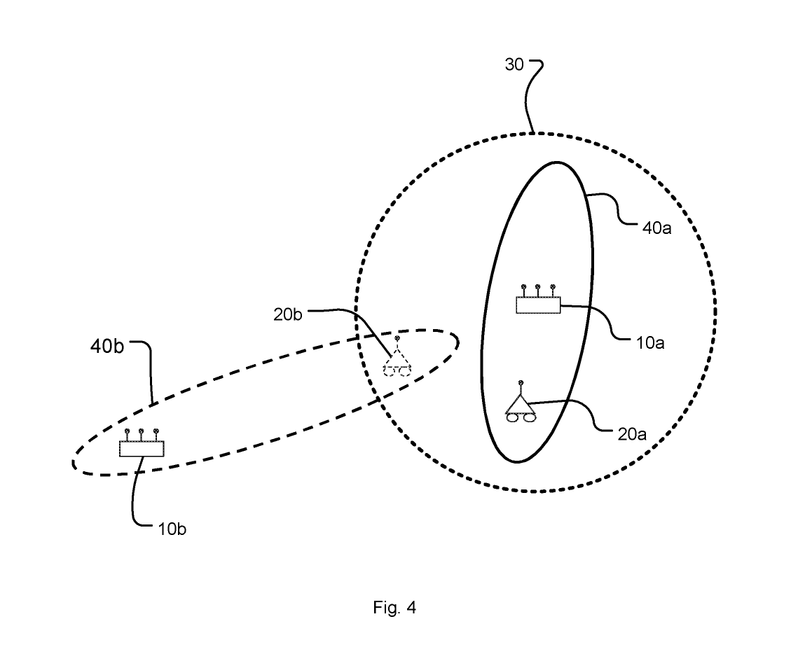

FIG. 4 illustrates a first access point 10a, in a wireless communication system, sending a receiver channel reservation signal 30 according to one aspect of the disclosure. The receiver channel reservation, RCR, signal 30 in FIG. 4 announces reception of transmission 40a from first user equipment 20a. The wireless communication system typically operates on the super high frequency band of above 3 GHz.

The RCR includes e.g. a specification of the time and or frequency interval during which the channel is reserved and the geographical or physical location of where the channel is reserved during the given time interval. This information allows other nodes in the wireless network to plan and effectively perform spatial reuse of the communication channel. The disclosure is in particular applicable but not limited to situations where directive communication transmissions are used.

In FIG. 4 a second user equipment 20b hears the receiver channel reservation signal 30. The second user equipment 20b is about to transmit another signal 40b to a second access point 10b. Based on the information in the receiver channel reservation signal 30, the second access point can make decisions regarding the intended transmission 40b in order to minimise interference in the system.

The information sent in the Request To Send, RTS, and Clear To Send, CTS, in a CDMA/CD system normally contains a network allocation vector, NAV. The NAV specifies when the channel is blocked and typically in the standard RTS/CTS 802.11 distributed coordination function, DCF, this is a timestamp when the total message exchange will end i.e. indicating when the sequence of messages RTS-CTS-DATA-ACK will end, see background section.

This disclosure extends the concept and adopts it to be more effective when directional transmissions are used. Note that the disclosure is not limited to directional transmissions but here we use this as an example implementation. The receiver channel reservation, RCR, contains information on when the transmitter will need the channel for receiving incoming transmissions.

The proposed approach has the benefit of allowing other communication links (a second pair of communicating nodes) to perform transmissions that were not allowed with the standard NAV behavior, and without causing harmful interference to the communication of the first pair of nodes i.e. the nodes specifying the RCR information in the RTS and CTS messages. Examples of such transmissions are transmissions that would cause harmful interference to the first transmitter, if it was in fact receiving, but since it is transmitting it is not disturbed by the second transmission, since the superposition principle in electromagnetic field theory gives that, for all linear systems, the net response at a given place and time caused by two or more stimuli is the sum of the responses which would have been caused by each stimulus individually. Hence, to be allowed, the second transmission is required to be directional and not to interfere with the receiver of the first transmission, as is indicated by the information in the RCR.

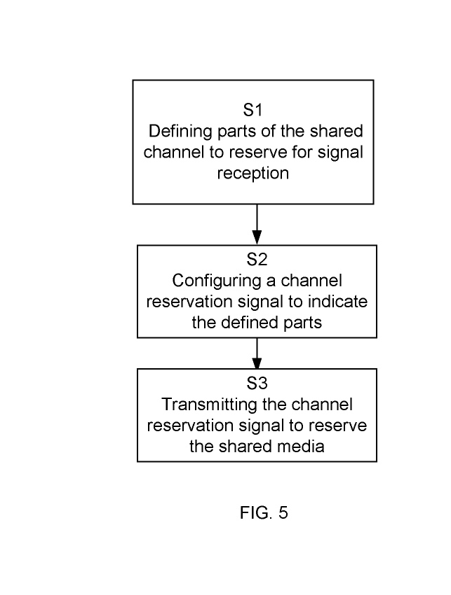

FIG. 5 is a flowchart illustrating a method performed in the first node 10a in a wireless communication system of FIG. 4, of reserving a shared media for signal reception. The method comprises defining S1, parts of the shared media to reserve for signal reception in the first node and configuring S2 a receiver channel reservation signal to indicate the defined parts. Finally it comprises transmitting S3 the receiver channel reservation signal to reserve the shared media. The steps will be described in further detail below.

The first step, S1, implies, defining, parts of the shared media to reserve for signal reception in the first node. This step implies defining when, and according to some aspects also “where”, the transmitter will need the channel for receiving incoming transmissions. Hence, in contrast to the NAV, which allocates the entire media during a complete transmission time interval, TTI, the receiver channel reservation signal explicitly defines when and or where the channel is needed for receiving incoming transmissions. Hence, in this context parts refer both to parts in time, frequency, code or space as will be further described below.

According to one aspect the receiver channel reservation signal comprises time information defining parts of the channel being reserved for signal reception. The RCR information may then comprise start and/or stop time, or start time and duration of the channel reservation. If it is possible to derive the complete time interval from a standardized transmission scheme, e.g. when the time duration of an ACK message is specified, then only one of these may be needed.

For example, for the sequence RTS-CTS-DATA-ACK the time interval indicated in the RCR info in the RTS message is the time interval during which the source node will receive the ACK and potentially even the CTS. Similarly the RCR info in the CTS message indicates the time interval when the destination node (the transmitter of the CTS) will receive the DATA transmission.

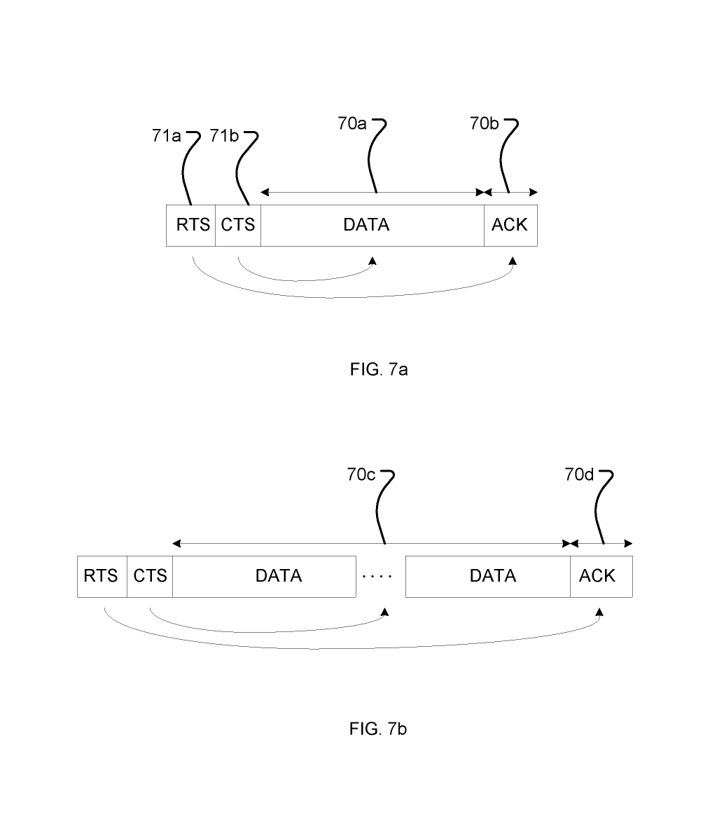

FIG. 7a illustrates time intervals indicated in a receiver channel reservation signal in order to illustrate the parts in time domain defined in the first step S1 of FIG. 5 in more detail. FIG. 7a illustrates what time interval 70b is reserved by a RTS 71a comprising a RCR in the cases of standard RTS-CTS-DATA-ACK scheme, and what time interval 70a is reserved by the CTS 71b comprising a RCR in the same scheme. In FIG. 7b block ACK is used to acknowledge several data packets at once. Then the channel is reserved, by the RCR comprised in the CTS, during the data transmission 70c and, by the RCR in the RTS, for reception of the block ACK 70d.

Now, returning to the method of FIG. 5. According to one further aspect of the present disclosure the receiver channel reservation signal comprises spatial information defining spatial parts of the channel being reserved for signal reception. This implies defining the physical or geographical properties of the reception such as the position of the first node. The location information can either be expressed in geographic coordinates (e.g. GPS coordinates) or an identity number identifying a receiver. For example, the location of where the channel is reserved, typically at the transmitter of the RCR information is included in the receiver channel reservation signal.

According to one aspect the signal reception in the first node is a directive transmission. Then the receiver channel reservation signal comprises directional information such as beam forming information or a direction.

Spatial information may in certain situations not be needed, e.g. when directional transmissions of RCR info, in RTS or CTS, are used and the receiver has the ability to determine from which direction, i.e. which set of antenna weights is affected by the incoming RCR information. In other situations the RCR may specify the channel to be reserved at the location of another receiver.

According to one aspect of the first step S1 of FIG. 5, the receiver channel reservation signal comprises spreading code information defining parts of the channel being reserved for signal reception. Another node receiving the receiver channel reservation signal may then choose to transmit a signal, which is separated from the announced reception in the code domain in order to avoid interference.

In the second step of FIG. 5, the first node 10a is configuring, S2, a receiver channel reservation signal 30 to indicate the defined parts 70. This implies configuring a signal comprising a message, such as a RTS or CTS and including receiver reservation data is the message. Hence, receiver channel reservation information is sent wirelessly in the form of a signal whose details carry the actual information or message, e.g. a RTS or CTS. Hence, this is typically an operation on the MAC level in the first node 10a. It should be acknowledged that the RCR is readily extended to other message exchange sequences and the disclosure is not limited to the RTS-CTS-DATA-ACK.

Finally, in the third step, the first node 10a transmits, S3, the receiver channel reservation signal to reserve the shared media. This step implies transmitting a physical signal on a physical channel, using the communication interface of the first node 10a. According to one aspect the receiver channel reservation signal is omnidirectional, as in FIG. 4. Then all nodes within a certain distance from the first node 10a will be informed about the announced reception in the first node.

According to one aspect the receiver channel reservation signal is transmitted on a frequency different from the frequency of the shared media. The location of the designated radio resource for the receiver channel reservation signal may be located on a separate frequency band possibly in a lower frequency range than that of the directional transmission to achieve a larger coverage area. In order to avoid transmitting and receiving at the same time using the same radio, a separate radio may be needed to support the omnidirectional transmission while receiving the directional transmission.

According to another aspect the receiver channel reservation signal is transmitted on the same frequency as the shared media. The principle of protecting a receiver with a receiver channel reservation signal is applicable to both scenarios.

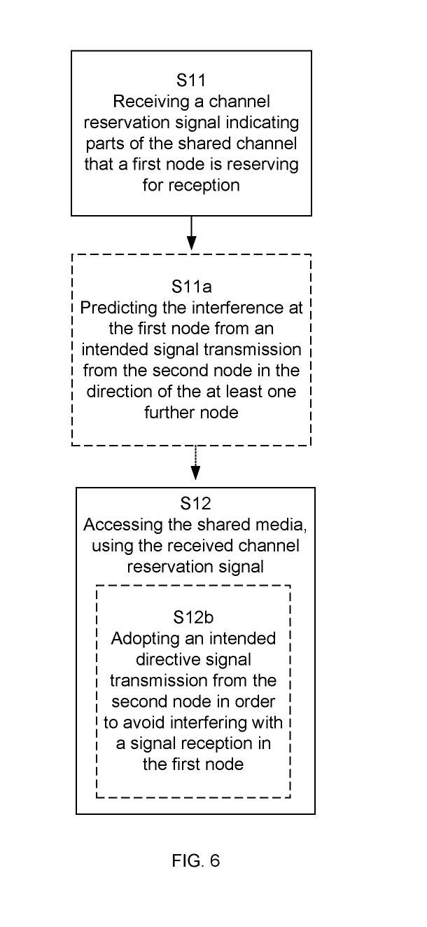

FIG. 6 is a flowchart illustrating method steps executed in a second node 20b when receiving a receiver channel reservation signal transmitted by a first node 10a. In this example the second node 20b intends to perform a transmission 40b to a second access point 10b. According to one aspect of the present disclosure the second node 20b will use the receiver channel reservation signal for accessing the media.

Hence, FIG. 6 discloses a method performed in a second node 20b in a wireless communication system, of accessing a shared media for signal transmission from the second node to at least one further node. The method comprises receiving S11, from a first node 10a a receiver channel reservation signal 30 indicating parts of the shared media that the first node 10a is reserving for signal reception and accessing S12 the shared media, using information contained in the received receiver channel reservation signal. The steps will be described in further detail below.

The method is typically executed when a second node 20b intends to transmit data to a further node 10b. In the first step, the second node 20b receives S11 the receiver channel reservation signal, transmitted by the first node 10a, indicating parts of the shared media that the first node 10a is reserving for signal reception. The receiver channel reservation signal informs the second node 20b that there is a potentially colliding transmission over the shared media.

In the next step accessing S12 the shared media, using information contained in the received receiver channel reservation signal. This step implies that the second node 20b takes the potentially colliding transmission into account when accessing the media. Accessing the shared media comprises e.g. a signal transmission from the second node 20b. According to one aspect the transmission from the second node is a directive transmission. This implies that the intended transmission from the second node 20b does not utilize the entire shared media. Then, the information in the received receiver channel reservation signal may be utilised in order to make sure that the reception in the first node is not disturbed. This may be done in many different ways as will be further explained below.

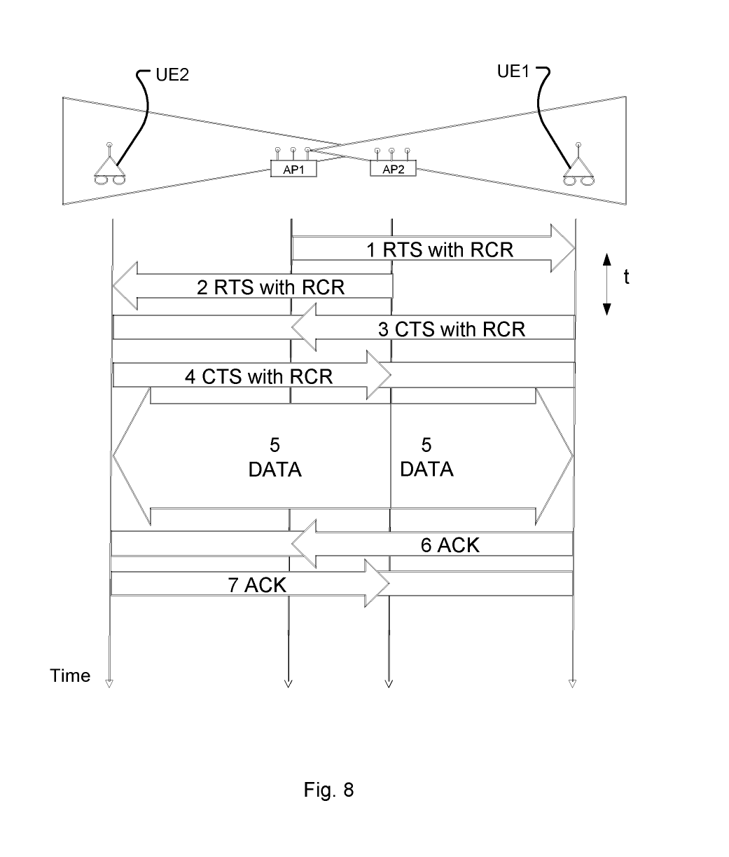

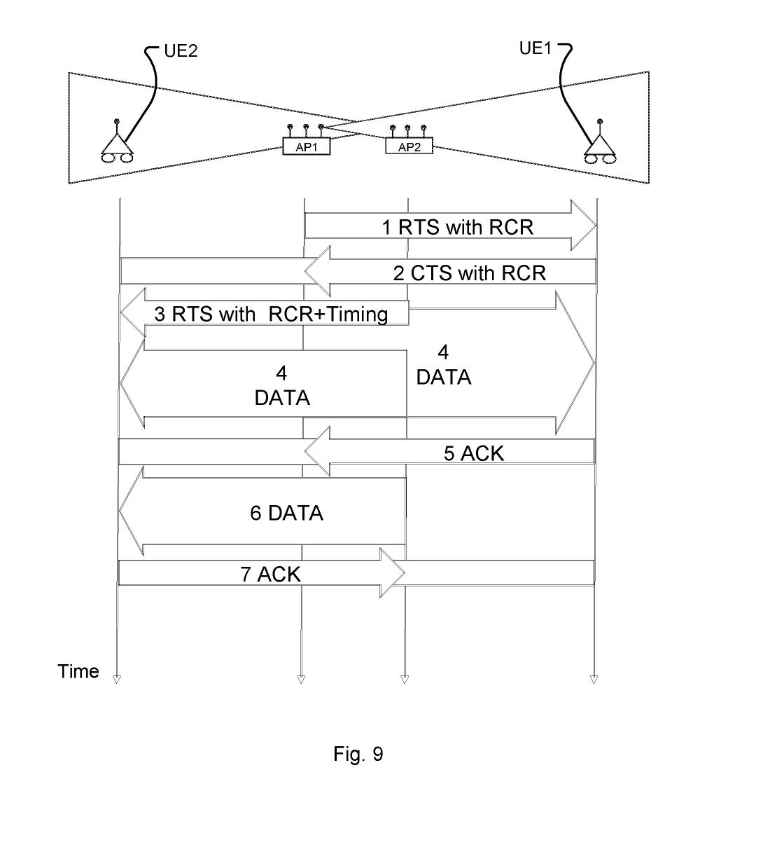

According to one aspect, the second node refrains from accessing the parts of the shared media that the first node has announced that it has reserved to use for signal reception. According to one aspect the step of accessing the shared media using the received receiver channel reservation signal comprises, using time information comprised in the receiver channel reservation signal. Implementations of this aspect are illustrated in FIGS. 8 and 9.

FIG. 8 illustrates an example embodiment where spatial reuse is possible using a receiver channel reservation signal, wherein it would not have been possible with a standard NAV.

In FIG. 8 a first node, in this example an access point referred to as AP1, has data to send to user equipment UE1 and a second node, another access point referred to as AP2, has data to send to a second user equipment UE2. The proposed scheme for RTS-CTS timing is such that it allows one, this may be extended to several, other RTS message to be sent in between the RTS message and the CTS message allowing spatial reuse. Hence, some time t is left out between the RTS and the CTS to allow interleaving one other exchange of RTS and CTS messages.

Note that in the current example when AP1 transmits to UE1 it causes interference at AP2. In a similar manner when UE1 transmits to AP1, it causes interference at both AP2 and UE2. When AP2 transmits to UE2 it causes interference at AP1, and when UE2 transmits to AP2 it causes interference at both AP1 and UE1.

The steps in FIG. 8 are:
1. AP1 sends an RTS including RCR to UE1. AP2 will also decode the RCR and know when it must not transmit to UE2, i.e., when the ACK from UE1 will be transmitted. AP2 plans its data transmission to be concurrent with the data transmission of AP1.
2. AP2 sends an RTS including RCR to UE2. AP1 decodes this message and knows when it must not transmit to UE1, this however will not affect the intended AP1-UE1 communication since AP2 has planned a non-interfering transmission.
3. UE1 transmits CTS including RCR to AP1. AP2 will decode this message and know when it must not interfere at AP1, i.e. when it must not transmit to the UE2.
4. UE2 transmits CTS including RCR to AP2. UE1 and any other receiver will decode this message and in particular UE1 will know when it may not transmit to AP1.
5. Both AP1 and AP2 transmit data to their respective UE.
6. UE1 transmits ACK to AP1
7. UE2 transmits ACK to AP2. This transmission is delayed in order not to interfere with the reception of the ACK in AP1.

FIG. 9 illustrates another example embodiment of a message exchange sequence for spatial reuse of a channel using a receiver channel reservation signal.

The illustration represents a different implementation of how to use the information in RCR. Note that the setup and interference situation between the nodes is the same as in the example embodiment of FIG. 8. The steps in FIG. 9 are:
1. AP1 transmits RTS including RCR to UE1. AP2 will now know when the ACK will be transmitted from UE1 to AP1.
2. UE1 transmits CTS including RCR to AP1. AP2 and UE2 will now know when the data transmission will occur.
3. AP2 sends a RTS including a RCR+timing message, intended to inform the UE2 of when the data transmission will happen and that no CTS message is needed. The timing part of the message indicates in this example that the data transmission will pause during the transmission of the ACK from UE1 to AP1.
4. AP1 sends data to UE1 at the same time as AP2 sends data to UE2
5. UE1 sends ACK to AP1, during this transmission AP2 pauses its data transmission
6. AP2 continues its data transmission to UE2
7. UE2 sends ACK to AP2

The transmission in this example has the benefit of not wasting any resources for the communication between AP1 and UE1. Remember that in the example of FIG. 8 some time t was left out between the RTS and the CTS exchanged between AP1 and UE1 in order to allow interleaving of another exchange of RTS and CTS messages, i.e. between AP2 and UE2. If no other such message exchange were to occur those resources would be left unused and hence the channel would not be effectively used. Note that t may be chosen to allow one or more interleaved RTS and CTS messages and that it may be chosen dynamically based on e.g. the number of nodes contending for medium access and/or the load in the system.

The drawback with this second approach is that there is no CTS with RCR message sent from UE2. This implies that the channel is not reserved at the location of UE2 and hence interference free transmission from AP2 to UE2 cannot be guaranteed.

Returning to FIG. 6, according to one aspect of the disclosure, the step of accessing the shared media comprises accessing the shared media, based on the received information comprises, using spatial information comprised in the receiver channel reservation signal. According to one particular aspect of the disclosure, the method of accessing a shared media further comprises predicting S11a, using the receiver channel reservation signal, an estimated interference at the first node 10a of intended signal transmission from the second node 20b in the direction of the at least one further node and accessing the shared media for transmission based on the determined interference. This implies e.g. that the nodes will do calculations based on the channel gain between the involved nodes to conclude if its intended transmission will interfere or not. The channel gain values may be measured values estimated using channel propagation models. One example implementation of the calculation is that the second node 20b uses the channel model and uses the spatial information to derive a channel gain to the receiver 10a (i.e., the transmitter of the receiver channel reservation signal).

According to one aspect of the disclosure, the step of accessing S12 a shared media further comprises adopting, step S12b in FIG. 6, an intended directive signal transmission from the second node 20b in order to avoid interfering with the signal reception in the first node 10a. The intended transmission may e.g. be delayed in time in order to interfere with the reception in the first node. The transmission may also be altered using e.g. different beam forming techniques or codes. According to one particular aspect, the second node 20b adopts, the transmit power of its own intended transmission using said channel gain to ensure that the resulting interfering signal strength at the receiver 10a is not above a predetermined threshold. The predetermined threshold is in one aspect derived from regulatory rules and in another implementation adjusted dynamically based on feedback passed between nodes in the same network. The feedback is in one aspect conveyed by messages indicating if a certain node is experiencing unacceptably high interference or not.

According to another aspect the step of accessing the shared media using the received receiver channel reservation signal comprises using frequency information comprised in the receiver channel reservation signal. Frequency information may also be used for determining interference. The frequency information indicates e.g. at what frequency (band or set of subcarriers) the announced receiver channel reservation is valid. That is, on what frequency (band or set of subcarriers) the receiver intends to receive the upcoming transmission. The frequency information is present in the receiver channel reservation signal to limit the reservation to only the relevant communication resources and to allow other concurrent transmissions to take place on other orthogonal resources.

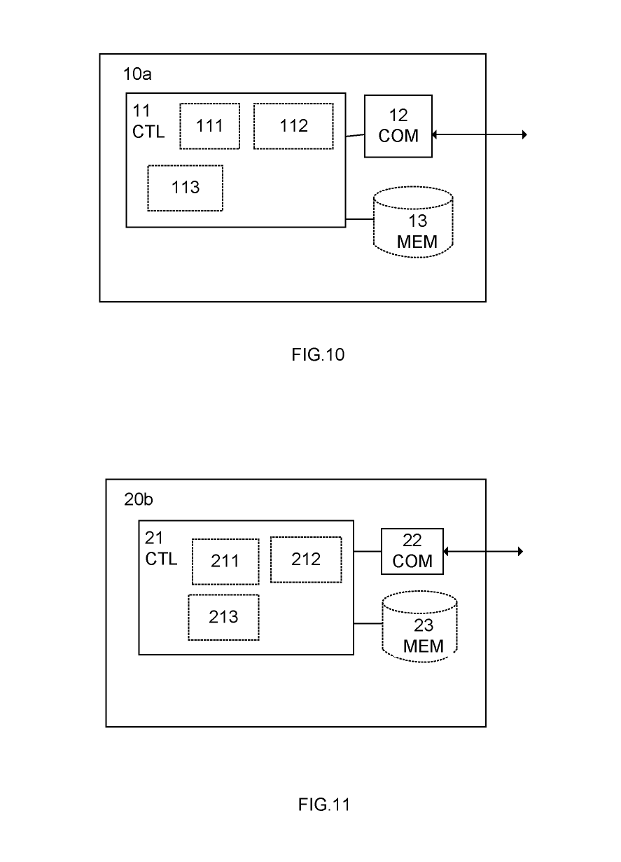

According to one aspect, the step of accessing the shared media based on the received information, comprises using code information comprised in the receiver channel reservation signal. As for the abovementioned frequency information, the code information present in one aspect of the disclosure is present in the receiver channel reservation signal to indicate what codes will be used in the upcoming transmission that the receiver intend to receive, this to allow other concurrent transmissions with orthogonal codes. Turning now to FIGS. 10 and 11 schematic diagrams illustrating some modules of an exemplary aspect of a first node 10a and a second node 20b will be described. In this application the term node is generally used. A node is any wireless device in a wireless communication system. Hence, the node may be an access point 10a, 10b, a user equipment 20a, 20b or any other device in the wireless communication comprising means for accessing the shared media.

The nodes comprise a controller, CTL, or a processing circuitry 11, 21 that may be constituted by any suitable Central Processing Unit, CPU, microcontroller, Digital Signal Processor, DSP, etc. capable of executing computer program code. The computer program may be stored in a memory (MEM) 13, 23. The memory 13, 23 can be any combination of a Read And write Memory, RAM, and a Read Only Memory, ROM. The memory 13, 23 may also comprise persistent storage, which, for example, can be any single one or combination of magnetic memory, optical memory, or solid state memory or even remotely mounted memory. The radio network nodes 10a and 20b further comprises a communication interface (i/f), 12 and 22 respectively, arranged for wireless communication with other devices or nodes, such as the wireless device 20a, 10b.

FIG. 10 discloses a first node configured for reserving a channel for signal transmission from the second node 20b to at least one further node 10b. When the above-mentioned computer program code is run in the processing circuitry 11 of the node 10a, it causes the node 10a to define, parts of the shared media to reserve for signal reception in the first node, configure a receiver channel reservation signal to indicate the defined parts and transmit, using the communication unit, the receiver channel reservation signal to reserve the shared media.

According to one aspect of the disclosure the processing circuitry comprises:
a definer 111 for defining, parts of the shared media to reserve for signal reception in the first node and
a signal configurer 112 for configuring a receiver channel reservation signal to indicate the defined parts and
a transmitter module 113 for transmitting the receiver channel reservation signal to reserve the shared media as further described above.

The definer 111, the signal configurer 112 and the transmitter module 113 are implemented in hardware or in software or in a combination thereof. The modules 111, 112, 113 are according to one aspect implemented as a computer program stored in a memory 13 which run on the processing circuitry 11.

FIG. 11 discloses a second node in a wireless communication system, configured for reserving a channel for signal transmission from the second node to at least one further node.

When the above-mentioned computer program code is run in the processing circuitry 21 of the node 20b, it causes the node 20b to receive, using the a communication unit, from a first node a receiver channel reservation signal indicating parts of the shared media that the first node is reserving for signal reception, and access, using the a communication unit, the shared media, using information contained in the received receiver channel reservation signal.

According to one aspect of the disclosure the processing circuitry 21 comprises:
a receiver module 211 for receiving, from a first node a receiver channel reservation signal indicating parts of the shared media that the first node is reserving for signal reception and
an access module 212 for accessing the shared media, using information contained in the received receiver channel reservation signal.

According to one aspect the processing circuitry further comprises a predictor 213 for predicting an estimate of the interference at the first node 10a of an intended signal transmission 40b from the second node 20b in the direction of at least one further node.

The receiver module 211, the access module 212 and the predictor 213 are implemented in hardware or in software or in a combination thereof. The modules 211 to 213 are according to one aspect implemented as a computer program stored in a memory 23 which runs on the processing circuitry 21.

Hence, according to a further aspect the disclosure relates to a computer program, comprising computer readable code which, when run on a node in a cellular communication system, causes the node to perform any of the methods described above.

1. A method, performed in a first node in a wireless communication system, of reserving a shared media for signal reception, the method comprising:
defining, parts of the shared media to reserve for signal reception in the first node;
configuring a receiver channel reservation signal to indicate the defined parts; and
transmitting the receiver channel reservation signal to reserve the shared media.

2. The method of reserving a shared media according to claim 1, wherein the receiver channel reservation signal comprises time information defining parts of the channel being reserved for signal reception.

3. The method of reserving a shared media according to claim 1, wherein the receiver channel reservation signal comprises frequency information defining the parts of the frequency spectrum being reserved for signal reception.

4. The method of reserving a shared media according to claim 1, wherein the receiver channel reservation signal comprises spatial information defining spatial parts of the channel being reserved for signal reception.

5. The method of reserving a shared media according to claim 1, wherein the receiver channel reservation signal comprises spreading code information defining parts of the channel being reserved for signal reception.

6. The method of reserving a shared media according to claim 1, wherein the receiver channel reservation signal is omnidirectional.

7. The method of reserving a shared media according to claim 1, wherein the receiver channel reservation signal is transmitted on a frequency different from the frequency of the shared media.

8. The method of reserving a shared media according to claim 1, wherein the receiver channel reservation signal is transmitted on the same frequency as the shared media.

9. The method of accessing a shared media according to claim 1, wherein the signal reception in the first node is a directive transmission

10. A method, performed in a second node in a wireless communication system, of accessing a shared media for signal transmission from the second node to at least one further node, the method comprising:
receiving from a first node a receiver channel reservation signal indicating parts of the shared media that the first node is reserving for signal reception, and
accessing the shared media, using information contained in the received receiver channel reservation signal.

11. The method of accessing a shared media, according to claim 10, wherein the step of accessing the shared media, comprises refraining from accessing the parts of the shared media, that the first node has announced that it has reserved to use for signal reception.

12. The method of accessing a shared media according to claim 10, further comprising:
predicting, using the receiver channel reservation signal, an estimate of the interference at the first node of an intended signal transmission from the second node in the direction of the at least one further node and accessing the shared media for transmission based on the determined interference.

13. The method of accessing a shared media according to claim 10, further comprising:
adopting an intended directive signal transmission from the second node in order to avoid interfering with the signal reception in the first node.

14. The method of accessing a shared media, according to claim 10, wherein the step of accessing the shared media comprises a signal transmission from the second node.

15. The method of accessing a shared media according to claim 10, wherein the step of accessing the shared media using the received receiver channel reservation signal comprises, using frequency information comprised in the receiver channel reservation signal.

16. The method of accessing a shared media according to claim 10, wherein the step of accessing the shared media using the received receiver channel reservation signal comprises, using time information comprised in the receiver channel reservation signal.

17. The method of accessing a shared media according to claim 10, wherein the step of accessing the shared media using the received receiver channel reservation signal comprises, using spatial information comprised in the receiver channel reservation signal.

18. The method of accessing a shared media according to claim 10, wherein the step of accessing the shared media using the received receiver channel reservation signal comprises, using code information comprised in the receiver channel reservation signal.

19. The method of accessing a shared media according to claim 10, wherein the transmission from the second node is a directive transmission.

20. The method according to claim 1, wherein the wireless communication system operates in a frequency band above 3 GHz.

21. A first node in a wireless communication system, being configured for reserving a shared media for signal reception, the first node comprising:
a communication unit and
processing circuitry adapted to:
define, parts of the shared media to reserve for signal reception in the first node;
configure a receiver channel reservation signal to indicate the defined parts; and
transmit, using the communication unit, the receiver channel reservation signal to reserve the shared media.

22. A second node in a wireless communication system,
configured for reserving a channel for signal transmission from the second node to at least one further node, the second node comprising
a communication unit and
processing circuitry adapted to:
receive, using the a communication unit, from a first node a receiver channel reservation signal indicating parts of the shared media that the first node is reserving for signal reception, and
access, using the a communication unit, the shared media, using information contained in the received receiver channel reservation signal.

23. (canceled)
